(19) United States
(12) Patent Application Publication
(10) Pub. No.: US 2026/0048361 A1
(43) Pub. Date: Feb. 19, 2026

(54) CO-CURRENT CONTACTOR WITH PARTICULATE DISPERSION FOR HEAT MANAGEMENT

(71) Applicant: INDUSTRIAL CLIMATE SOLUTIONS INC., Calgary (CA)

(72) Inventor: Yash Tamhankar, Bartlesville, OK (US)

(21) Appl. No.: 18/806,994

(22) Filed: Aug. 16, 2024

(51) Int. Cl. B01D 53/14; B01D 53/18

(52) U.S. Cl. CPC B01D 53/1431; B01D 53/1475; B01D 53/18; B01D 2257/504

(57) ABSTRACT

A system including an absorption column, and one or more lines configured to feed a solvent, particulates, and a gas comprising a component to the absorption column, wherein the absorption column is configured to induce co-current flow of the gas, the solvent, and the particulates therethrough, such that the solvent absorbs the component from the gas to form rich solvent and lean gas and the particulates absorb heat generated during the co-current flow to form heated particulates. A method including feeding a solvent, particulates, and a gas comprising a component to an absorption column, and inducing co-current flow of the gas, the solvent, and the particulates through the absorption column such that the solvent absorbs the component from the gas to form rich solvent and lean gas and the particulates absorb heat generated during the co-current flow to form heated particulates.

### BACKGROUND

Various manufacturing and chemical systems, e.g., oil refineries, produce flue gases including components such as carbon dioxide. While the flue gases from these systems may be exhausted into the atmosphere, it is desirable to remove one or more of the components, e.g., carbon dioxide, from the flue gases prior to release into the atmosphere. In the case of carbon dioxide, such removal is referred to as carbon capture. Additionally, it may be desirable to remove a component, e.g., carbon dioxide, from atmospheric air. In the case of carbon dioxide, such removal is referred to as direct air capture (DAC). Improvements to systems for capturing a component from flue gases and/or atmospheric air may be desirable.

### SUMMARY

An embodiment of a system including an absorption column, and one or more lines configured to feed a solvent, particulates, and a gas comprising a component to the absorption column, wherein the absorption column is configured to induce co-current flow of the gas, the solvent, and the particulates therethrough, such that the solvent absorbs the component from the gas to form rich solvent and lean gas and the particulates absorb heat generated during the co-current flow to form heated particulates.

An embodiment of a method including feeding a solvent, particulates, and a gas comprising a component to an absorption column, and inducing co-current flow of the gas, the solvent, and the particulates through the absorption column such that the solvent absorbs the component from the gas to form rich solvent and lean gas and the particulates absorb heat generated during the co-current flow to form heated particulates.

### BRIEF DESCRIPTION OF THE DRAWINGS

The following descriptions should not be considered limiting in any way. With reference to the accompanying drawings, like elements are numbered alike:

FIG. 1 shows a simplified schematic diagram of a system according to one or more embodiments;

FIG. 2A shows an upper view of a corrugated screen packing module according to one or more embodiments;

FIG. 2B shows a perspective view of a corrugated screen according to one or more embodiments; and

FIG. 3 shows a flowchart of a process of capturing a component of a flue gas according to one or more embodiments.

### DETAILED DESCRIPTION

A detailed description of one or more embodiments of the disclosed apparatus and method are presented herein by way of exemplification and not limitation with reference to the Figures.

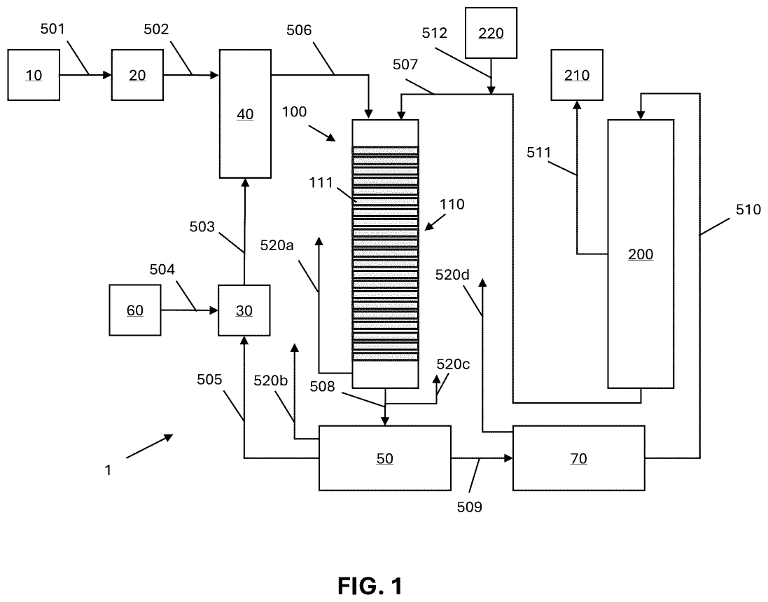

A simplified schematic diagram of a system 1 according to one or more embodiments is shown in FIG. 1. The system 1 may be, for example, a carbon capture system, although the present disclosure is not limited thereto. The system 1 may include a flue gas source 10. The flue gas source 10 may be, for example, a manufacturing or chemical system that produces a flue gas which may contain, for example, carbon dioxide. The flue gas source 10 may be an oil refinery. While FIG. 1 shows the system 1 processing gas from a flue gas source 10, the system 1 may instead process environmental air. Thus, while the present disclosure discusses processing of flue gases, it should be understood that environmental air may replace the flue gas in the system 1.

The system 1 may include a cooler 20 downstream of the flue gas source 10 that receives the flue gas from the flue gas source 10 via a flue gas line 501 that extends between the cooler 20 and the flue gas source 10, and that cools the flue gas. The cooler 20 may be, for example, a direct contact cooler or any other cooler that a person skilled in the art could use. The cooler 20 may cool the flue gas to near, at, or below ambient temperatures. The cooler 20 may spray water or other liquid to cool the flue gas while humidifying the flue gas. The cooler 20 may include fans, liquid heat exchangers, and/or other cooling structures known in the art. The system 1 may omit the cooler 20 if, e.g., the flue gas has a desired temperature before an absorption column 100.

The system 1 may include a particulate source 30 that receives fresh particulates from a fresh particulate source 60 via a fresh particulate line 504 that extends between the fresh particulate source 60 and the particulate source 30 and/or receives recycled particulates from a particulate disengagement structure 50, described in detail below, via a recycled particulate line 505 that extends between the particulate disengagement structure 50 and the particulate source 30. That is, the fresh particulate source 60 and/or the particulate disengagement structure 50 may feed the particulates into the particulate source 30.

The system 1 may include a particulate and flue gas mixture source 40 which receives the cooled flue gas from the cooler 20 via a cooled gas line 502 and receives particulates from the particulate source 30. The flue gas mixture source 40 may mix the cooled flue gas and the particulates. The flue gas mixture source 40 may also receive flue gas directly from the flue gas source 10.

While FIG. 1 shows a fresh particulate line 504, a recycled particulate line 505, and a particulate line 503 for moving the particulates, the particulates may alternatively be transported between the particulate disengagement structure 50, the fresh particulate source 60, the particulate source 30, and/or the flue gas mixture source 40 via other methods. For example, a conveyor, a vehicle, and/or other structures may be used to transport the particulates. Alternatively, part of the flue gas from the flue gas line 501 could be utilized to carry the particulates to flue gas mixture source 40. Alternatively, the cooled particulates could be dispersed into the lean solvent line 507 prior to injection into the absorption column 100.

The system 1 further includes an absorption column 100. A particulate and flue gas mixture line 506 may extend from the particulate and flue gas mixture source 40 to the absorption column 100 to feed the particulates and the flue gas from the particulate and flue gas mixture source 40 into the absorption column 100. Alternatively, the particulates and the flue gas may be fed separately into the absorption column 100.

The system 1 may include a lean solvent line 507 extending from a stripping structure 200 to the absorption column 100 that feeds lean solvent from the stripping structure 200 to the absorption column 100. While a stripping structure 200 is shown in FIG. 1, the system 1 may employ a regeneration structure and/or a desorption structure instead or in addition to the stripping structure 200. The absorption column 100 may alternatively or additionally receive lean solvent from a fresh solvent source 220 via a fresh solvent line 512 extending from the fresh solvent source 220 to the lean solvent line 507. The fresh solvent source 220 may be, for example, a solvent tank that stores lean solvent. The lean solvent may be liquid solvent. As used herein, “lean solvent” may refer to solvent with little or no component, e.g., carbon dioxide, of the flue gas therein, and “rich solvent” may refer to a solvent with a significant amount of the component, e.g., carbon dioxide, of the flue gas absorbed therein. As used herein, “lean gas” may refer to the flue gas after the component, e.g., carbon dioxide, has been removed therefrom via the absorption column 100 such that it has little or none of the component, e.g., carbon dioxide therein. The solvent may be an amine, amino acid salts, carbonate systems, aqueous ammonia, immiscible liquids, ionic liquids, or another liquid solvent known in the art that is effective for capturing the component.

The stripping structure 200 may be any stripping structure for separating a component, e.g., carbon dioxide, from rich solvent. As a non-limiting example, the stripping structure 200 may include a stripper column, a reboiler, a condenser, and a reflux drum, a solvent tank, and/or a cooler. The stripper column may include packing material, trays, sprays, etc. As noted above, a regeneration structure and/or a desorption structure instead or in addition to the stripping structure 200. In the case of the desorption structure, a desorption column/equipment may be employed for pressure-swing operation such as a flash column.

The absorption column 100 may be a regenerative froth contactor (RFC) equipped with a corrugated screen packing assembly 110 that includes a plurality of corrugated screen packing modules 111. The absorption column 100 may induce co-current flow of the flue gas and the lean solvent through the corrugated screen packing assembly 110. That is, the absorption column 100 may include a co-current contactor system in the form of the corrugated screen packing assembly 110. The co-current flow of the flue gas and the lean solvent through the corrugated screen packing assembly 110 may result in a component of the flue gas, e.g., carbon dioxide, being absorbed into the lean solvent, removing the component from the flue gas and forming a rich solvent having the component absorbed therein. The particulates may be dispersed within the lean solvent and the flue gas within the absorption column. The particulates may also flow co-currently with the flue gas and the lean solvent.

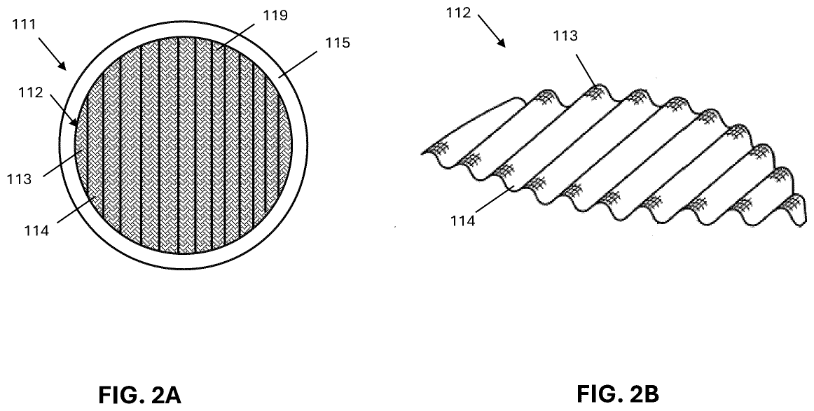

The flue gas and the lean solvent fed into the absorption column 100 may travel downstream in a gas-liquid co-flow configuration, with a pulse regime hydrodynamic condition. Each of the corrugated screen packing modules 111 may be formed of convoluted screens with apertures 119 (see FIG. 2A) sized and arranged to maximize the solvent pulsing effect while minimizing the metal packing material and allowing the particulates to pass through. The corrugated screen packing assembly 110 may induce the absorption column 100 to operate under a froth condition in two-phase flow with millions of bubbles and droplets being formed in the absorption column 100. The bubbles may be created as bands of froth collapse and are regenerated. The lean solvent in liquid phase and the flue gas in gaseous phase may be fed into the absorption column co-currently from the upstream portion, flow through corrugated screen packing assembly 110 in pulsing regime and disengage at the downstream portion of the absorption column 100. The pulse flow may occur due to a hydrodynamic multi-phase phenomenon depending on the flow rates and the design of the corrugated screen packing assembly 110. The flue gas may pass through multiple zones of froth along the corrugated screen packing assembly 110, and the component of the flue gas may get absorbed into the lean solvent.

According to one or more embodiments, the absorption column 100 may be a RFC equipped with a corrugated screen packing assembly 110 having no moving parts and may operate in a downward ‘co-flow’ configuration. The corrugated screen packing assembly may be formed of convoluted screens that may increase a solvent pulsing effect, and may decrease metal packing material, by inducing the absorption column 100 to operate under a transient froth condition in two phase flow. The pulse flow may be set up as a hydrodynamic multi-phase phenomenon, corresponding to a specific region in a flow map within the absorption column 100. Mass transfer may take place in pulses of froth formed by gas and liquid. As bands of froth propagate down the absorption column 100, the absorber enables a high contact surface area and excellent mixing, with millions of bubbles and droplets created as bands of froth collapse and are regenerated. The component of the flue gas may thus be transferred from the flue gas into the liquid phase in the froth in a whole volume of the absorption column 100, while the corrugated screen packing assembly 110 may govern the froth. The applicable flow map may depend on characteristics of fluids and selected geometry of the corrugated screen packing assembly 110. For some gas/liquid systems, a geometry of the corrugated screen packing assembly 110 may be selected to enforce a preferred pulse area on the flow map and a coarser or thinner froth, through effects of the corrugated screen packing assembly 100 on the hydrodynamic regime.

An absorption column 100 may enable accommodation of high gas flow rates and liquid/gas ratios, without excessive back pressure or flooding within the absorption column 100. The absorption column 100 may also be used in processes with precipitating solvents or high levels of entrained solids, leading to three-phase contactors. The absorption column 100 may experience minimal or no fouling or additional pressure drop penalty, even under high particulate loads and high viscosity.

As the flue gas and the lean solvent flow co-currently through the corrugated screen packing assembly 110, an exothermic reaction may occur when the component, e.g., carbon dioxide, is absorbed from the flue gas into the lean solvent. The exothermic reaction may generate significant heat. Because of the co-current flow of the flue gas and the lean solvent, the heat flows downstream with the co-current flow. As the lean solvent heats up, the capacity thereof to absorb the component decreases. Therefore, according to one or more embodiments, the particulates are included in the co-current flow along with the flue gas and the lean solvent. The particulates may have high heat capacity and moderate to high thermal conductivity without reacting with the flue gas or the lean solvent. The particulates may absorb the heat generated by the exothermic reaction within the absorption column 100 such that an amount of heat absorbed by the lean solvent is reduced, thereby maintaining the capacity of the lean solvent to absorb the component at a greater degree than without the particulates. According to one or more embodiments, the particulates may be near or at ambient temperature. Alternatively, the particulates may be cooled to below ambient temperature.

Non-limiting examples of the particulates include Aluminum, cement, cement additives, metals such as Copper, Iron, and/or Lead, dry brick, concrete, concrete aggregates, granite, graphite, limestone, sand, sandstone, slag, sodium chloride, clay soil, gravelly soil, or any other particulates with sufficient heat retention capacity and appropriate particulate size. Material selection should be based on the application, balancing the heat capacity and the thermal conductivity required to remove sufficient heat from the solvent within the residence time of the fluids in the RFC. According to one or more embodiments, the particulates may have a maximum dimension between 1-250 microns. According to one or more embodiments, the particulates may have a maximum dimension between 5-200 microns. In order to allow the particulates to pass through the apertures 119 in the corrugated screen packing module 111 without excessive obstruction, the particulates may have a maximum dimension that is 10% or less of the minimum dimension of the apertures 119. In order to efficiently recover the particulates within a particulate disengagement structure 50 (to be described in detail below), the particulates may have a maximum dimension that is 5 microns or greater.

A non-limiting example of a corrugated screen packing module 111 is shown in FIG. 2A. The corrugated screen packing module 111 may include a frame 115 with a corrugated screen 112. The corrugated screen may include ridges 113 and valleys 114 in an alternating arrangement, a non-limiting example of which is shown in FIG. 2B. According to one or more embodiments, apertures 119 formed in the corrugated screen 112 may be sized to allow the particulates to pass therethrough. According to one or more embodiments, the apertures 119 formed in the corrugated screen 112 may have a minimum dimension of 500-2000 microns. According to one or more embodiments, the apertures 119 formed in the corrugated screen 112 may have a minimum dimension of 1000-1800 microns. According to one or more embodiments, the apertures 119 formed in the corrugated screen 112 may have a minimum dimension of 1200-1700 microns. According to one or more embodiments, the apertures 119 formed in the corrugated screen 112 may have a minimum dimension of 1400-1600 microns. According to one or more embodiments, the apertures 119 formed in the corrugated screen 112 may have a minimum dimension of 1500 microns.

The system 1 may include a particulate disengagement structure 50, and the absorption column 100 may be coupled to the particulate disengagement structure 50 via a particulate, lean gas, and a rich solvent mixture line 508 extending between the absorption column 100 and the particulate disengagement structure 50. A mixture of the particulates, the lean gas, and the rich solvent may exit the absorption column 100 via the particulate, lean gas, and rich solvent mixture line 508 and be received by the particulate disengagement structure 50. Alternatively, the lean gas may be separated from the mixture of the particulates, the lean gas, and the rich solvent, and removed from the absorption column 100 via a lean gas line 520a, from the particulate disengagement structure 50 via a lean gas line 520b, and/or from the particulate, lean gas, and rich solvent mixture line 508 upstream of the particulate disengagement structure 50 via a lean gas line 520c and removed from the system 1. The system 1 may include a separate structure (not shown) for separating the lean gas from the mixture of the particulates, the lean gas, and the rich solvent.

The particulate disengagement structure 50 is structured to separate the particulates from the mixture of the particulates, the lean gas, and the rich solvent (or the mixture of the particulates and the rich solvent if lean gas was previously removed). The particulate disengagement structure 50 may be, for example, an impingement device. As a non-limiting example, the particulate disengagement structure 50 may be structured to reduce the velocities of the mixture of the particulates, the lean gas, and the rich solvent (or the mixture of the particulates and the rich solvent if lean gas was previously removed) to separate out the particulates from the rich solvent and/or the lean gas.

The system 1 may include a separator structure 70 downstream of the particulate disengagement structure 50 that receives a mixture of the lean gas and the rich solvent via a lean gas and rich solvent mixture line 509 and may be structured to separate the lean gas from the rich solvent. The separator structure 70 may be any structure known in the art for separating gas from a liquid-gas mixture. The lean gas may be removed from the separator structure 70 via a lean gas line 520d and removed from the system 1. The system 1 may omit the separator structure 70 if the lean gas is separated at the absorption column 100 and/or the particulate disengagement structure 50.

The system 1 may include a stripping structure 200 (and/or a regeneration structure and/or a desorption structure) and a rich solvent line 510 extending from the separator structure 70 to the stripping structure 200. The stripping structure 200 may receive rich solvent from the separator structure 70 via a rich solvent line 510 and separate the component from the rich solvent to form lean solvent and the component in concentrated form. The lean solvent may be fed from the stripping structure 200 to the absorption column 100 via the lean solvent line 507 as described above. The component in concentrated form may be fed to a component tank 210, via a component line 511, or removed from the system 1 via the component line 511.

Although an example of carbon dioxide is set forth with respect to a component to be removed from the flue gas and/or environmental gas, the system 1 may also be applicable to H₂S, SO₂, O₂ COS, etc. As non-limiting examples, the system 1 may be applicable to H₂S removal with amine solvent, CO₂ removal with NaOH, SO₂ removal with NaOH, SO₂ removal with H₂O₂, SO₂ removal with HCl, O2 removal with aqueous Sodium sulfite, and COS removal with amine solvents, among others. The system 1 may be applicable to any application that involves gas absorption with an exothermic chemical reaction in solvent or a non-reactive solvent that may benefit from cooling or heat removal.

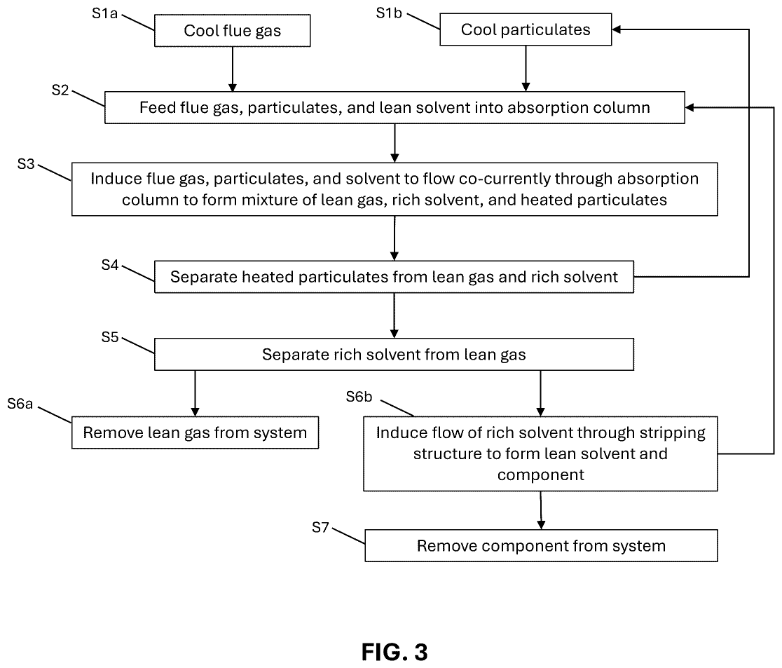

A flowchart showing a process of capturing a component of a flue gas according to one or more embodiments is shown in FIG. 3. Methods for capturing the component are not limited to the specific process shown in the flowchart, and steps may be omitted, replaced, or added in view of the above description. Furthermore, although references are made to elements of the system 1 shown in FIG. 1, the method is not limited to the system 1.

In step S1a, flue gas (or environmental air) containing a component, e.g., carbon dioxide, is cooled by a cooler 20, and in step S1b, particulates are cooled to near, at, or below ambient temperature. Alternatively, if the flue gas is already at a desired temperature, step S1a may be omitted. The flue gas, whether cooled in step S1a or not, may be humidified as desired as well. Further, particulates that are already near, at, or below ambient temperature may be provided such that step S1b may be omitted. In step S2, the flue gas, the particulates, and lean solvent are fed into an absorption column 100. In step S3, co-current flow of the flue gas, the particulates, and the lean solvent through the absorption column may be induced by, e.g., gravity, a pump, a fan, and/or other structures known in the art. The inducing of the co-current flow may include inducing co-current flow of the flue gas, the particulates, and the lean solvent through a corrugated screen packing assembly 110. Due to the co-current flow through the absorption column 100, the component is absorbed from the flue gas by the lean solvent, and the particulates absorb the heat generated by the absorption process. Thus, lean gas, rich solvent, and heated particulates are formed in step S3. In step S4, the heated particulates are separated from the lean gas and the rich solvent via, e.g., a particulate disengagement structure 50, and the particulates separated in step S4 are cooled in step S1b. In step S5, the rich solvent is separated from the lean gas via, e.g., a separator structure 70. In step S6a, the lean gas is removed from the system 1 via, e.g., a lean gas line 520d, and in step S6b, flow of the rich solvent through a stripping structure 200 is induced to form lean solvent and the component in concentrated form, and the lean solvent is fed into the absorption column in step S2. In step S7, the component in concentrated form is removed from the system 1 via, e.g., a component line 511.

While specific configurations of the system 1 are set forth above, one or more elements of the system 1 may be used in a system that removes any other compound from flue gas, including but not limited to, corrosive gaseous emissions, acidic fumes, odors, sulfur dioxide, and carbon monoxide. One or more elements of the system 1 may also be used in any application that includes gas-liquid absorption.

Set forth below are some embodiments of the foregoing disclosure:

Embodiment 1: A system including an absorption column, and one or more lines configured to feed a solvent, particulates, and a gas comprising a component to the absorption column, wherein the absorption column is configured to induce co-current flow of the gas, the solvent, and the particulates therethrough, such that the solvent absorbs the component from the gas to form rich solvent and lean gas and the particulates absorb heat generated during the co-current flow to form heated particulates.

Embodiment 2: The system of any prior embodiment, wherein the absorption column is a regenerative froth contactor.

Embodiment 3: The system of any prior embodiment, wherein the absorption column comprises a corrugated screen packing assembly.

Embodiment 4: The system of any prior embodiment, wherein the system further comprises a particulate disengagement structure downstream of the absorption column configured to separate the particulates from the rich solvent and/or the lean gas.

Embodiment 5: The system of any prior embodiment, wherein the system is configured to cool the particulates downstream of the particulate disengagement structure and feed the particulates cooled by the particulate disengagement structure to the absorption column.

Embodiment 6: The system of any prior embodiment, further comprising a cooler upstream of the absorption column for cooling the gas being fed into the absorption column.

Embodiment 7: The system of any prior embodiment, wherein the system is configured to mix the gas and the particulates to form a mixture of the gas and the particulates and feed the mixture into the absorption column.

Embodiment 8: The system of any prior embodiment, wherein the corrugated screen packing assembly comprises a plurality of corrugated screen packing modules having apertures sized to allow the particulates pass therethrough.

Embodiment 9: The system of any prior embodiment, wherein a minimum dimension of the apertures is between 500-2000 microns.

Embodiment 10: The system of any prior embodiment, wherein a maximum dimension of the particulates is between 5-200 microns.

Embodiment 11: The system of any prior embodiment, wherein the cooler is configured to spray a liquid to cool and humidify the gas.

Embodiment 12: The system of any prior embodiment, wherein the particulate disengagement structure is an impingement device configured to slow a velocity of flow of the particulates.

Embodiment 13: The system of any prior embodiment, wherein the system comprises a stripping structure, a regeneration structure, or a desorption structure for removing the component from the rich solvent to form lean solvent and feed the lean solvent into the absorption column.

Embodiment 14: The system of any prior embodiment, wherein the system is a carbon capture system configured to remove carbon dioxide from the gas.

Embodiment 15: A method including feeding a solvent, particulates, and a gas comprising a component to an absorption column, and inducing co-current flow of the gas, the solvent, and the particulates through the absorption column such that the solvent absorbs the component from the gas to form rich solvent and lean gas and the particulates absorb heat generated during the co-current flow to form heated particulates.

Embodiment 16: The method of any prior embodiment, further comprising separating the particulates from the gas and/or the solvent.

Embodiment 17: The method of any prior embodiment, further comprising cooling the particulates separated from the gas and/or the solvent and feeding the particulates that have been cooled to the absorption column.

Embodiment 18: The method of any prior embodiment, further comprising cooling the gas prior to feeding the gas into the absorption column.

Embodiment 19: The method of any prior embodiment, further including separating the rich solvent from the lean gas, stripping the component from the rich solvent to form lean solvent, and feeding the lean solvent into the absorption column.

Embodiment 20: The method of any prior embodiment, wherein the inducing co-current flow of the gas, the solvent, and the particulates through the absorption column comprises flowing the gas, the solvent, and the particulates through corrugated screen packing modules having apertures having a minimum dimension between 500-2000 microns.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system comprising:
an absorption column; and
one or more lines configured to feed a solvent, particulates, and a gas comprising a component to the absorption column,
wherein the absorption column is configured to induce co-current flow of the gas, the solvent, and the particulates therethrough, such that the solvent absorbs the component from the gas to form rich solvent and lean gas and the particulates absorb heat generated during the co-current flow to form heated particulates.

2. The system of claim 1, wherein the absorption column is a regenerative froth contactor.

3. The system of claim 1, wherein the absorption column comprises a corrugated screen packing assembly.

4. The system of claim 1, wherein the system further comprises a particulate disengagement structure downstream of the absorption column configured to separate the particulates from the rich solvent and/or the lean gas.

5. The system of claim 4, wherein the system is configured to cool the particulates downstream of the particulate disengagement structure and feed the particulates cooled by the particulate disengagement structure to the absorption column.

6. The system of claim 1, further comprising a cooler upstream of the absorption column for cooling the gas being fed into the absorption column.

7. The system of claim 1, wherein the system is configured to mix the gas and the particulates to form a mixture of the gas and the particulates and feed the mixture into the absorption column.

8. The system of claim 3, wherein the corrugated screen packing assembly comprises a plurality of corrugated screen packing modules having apertures sized to allow the particulates pass therethrough.

9. The system of claim 8, wherein a minimum dimension of the apertures is between 500-2000 microns.

10. The system of claim 1, wherein a maximum dimension of the particulates is between 5-200 microns.

11. The system of claim 1, wherein the cooler is configured to spray a liquid to cool and humidify the gas.

12. The system of claim 1, wherein the particulate disengagement structure is an impingement device configured to slow a velocity of flow of the particulates.

13. The system of claim 1, wherein the system comprises a stripping structure, a regeneration structure, or a desorption structure for removing the component from the rich solvent to form lean solvent and feed the lean solvent into the absorption column.

14. The system of claim 1, wherein the system is a carbon capture system configured to remove carbon dioxide from the gas.

15. A method comprising:
feeding a solvent, particulates, and a gas comprising a component to an absorption column; and
inducing co-current flow of the gas, the solvent, and the particulates through the absorption column such that the solvent absorbs the component from the gas to form rich solvent and lean gas and the particulates absorb heat generated during the co-current flow to form heated particulates.

16. The method of claim 15, further comprising separating the particulates from the gas and/or the solvent.

17. The method of claim 16, further comprising cooling the particulates separated from the gas and/or the solvent and feeding the particulates that have been cooled to the absorption column.

18. The method of claim 15, further comprising cooling the gas prior to feeding the gas into the absorption column.

19. The method of claim 15, further comprising:
separating the rich solvent from the lean gas;
stripping the component from the rich solvent to form lean solvent; and
feeding the lean solvent into the absorption column.

20. The method of claim 15, wherein the inducing co-current flow of the gas, the solvent, and the particulates through the absorption column comprises flowing the gas, the solvent, and the particulates through corrugated screen packing modules having apertures having a minimum dimension between 500-2000 microns.
